(19) United States
(12) Patent Application Publication
(10) Pub. No.: US 2025/0245417 A1
(43) Pub. Date: Jul. 31, 2025

(54) SYSTEMS AND METHODS OF AUTOMATED GENERATION OF TEXTUAL USER INTERFACE ELEMENTS

(71) Applicant: Walmart Apollo, LLC, Bentonville, AR (US)

(72) Inventors: Varun A. Vasudevan, Palo Alto, CA (US); Faezeh Akhavizadegan, Mountain View, CA (US); Yokila Arora, San Jose, CA (US); Hyun Duk Cho, San Francisco, CA (US); Sushant Kumar, San Jose, CA (US); Kannan Achan, Saratoga, CA (US)

(21) Appl. No.: 19/025,867

(22) Filed: Jan. 16, 2025

Related U.S. Application Data
(60) Provisional application No. 63/626,995, filed on Jan. 30, 2024.

(51) Int. Cl. G06F 40/10

(52) U.S. Cl. CPC G06F 40/10

(57) ABSTRACT

Example implementations relate to generating textual user interface elements. A request to generate a textual user interface element for a selected interface element package is received. The request includes a plurality of targeted characteristics of the textual user interface element. In response to receiving the request, an input prompt based on first information derived from the plurality of targeted characteristics is generated. The initial textual user interface element based on first criteria is processed to generate a processed textual user interface element. At least the first criteria or the first information based on feedback information of the processed textual user interface element is modified. The textual user interface element based on the modified first criteria and/or the modified first information is generated.

### CROSS-REFERENCE TO RELATED APPLICATIONS

This application claims priority to U.S. Provisional Patent Application No. 63/626,995, filed Jan. 30, 2024, entitled “Systems and Methods of Automated Generation of Textual User Interface Elements,” which is incorporated by reference herein in its entirety.

### TECHNICAL FIELD

This application relates generally to automated generation of textual user interface elements, and more particularly, to automated generation of textual user interface elements for interface element packages.

### BACKGROUND

Some content items, such as banners, include user interface element packages having both a graphical user interface element (e.g., an image, a video, etc.) and a textual user interface element. Manual generation of context-appropriate textual user interface elements for a variety of such content items (e.g., that change with time) is burdensome and time consuming. Alternatively, the use of a limited set of textual user interface elements may reduce user engagement and may not be able to provide information that is personalized for a user's specific interests.

### BRIEF DESCRIPTION OF THE DRAWINGS

Various examples will be described by the following detailed description, which is to be considered together with the accompanying drawings wherein like numbers refer to like parts and further wherein:

FIG. 1 illustrates a network environment that provides automated textual user interface element generation, in accordance with some embodiments;

FIG. 2 illustrates a computer system that implements one or more processes, in accordance with some embodiments;

FIG. 3 is a flowchart illustrating a textual user interface element generation method, in accordance with some embodiments;

FIG. 4 is a process flow illustrating various steps of the textual user interface element generation method of FIG. 3, in accordance with some embodiments;

FIG. 5A illustrates an example interface element package, in accordance with some embodiments;

FIG. 5B illustrates an example process flow of a textual user interface element generation method, in accordance with some embodiments;

FIG. 6A and FIG. 6B illustrate example user interfaces for generating a textual user interface element generation request, in accordance with some embodiments;

FIG. 7 illustrates an artificial neural network, in accordance with some embodiment;

FIG. 8 illustrates a deep neural network (DNN), in accordance with some embodiments;

FIG. 9 is a flowchart illustrating a training method for generating a trained machine learning model, in accordance with some embodiments; and

FIG. 10 is a process flow illustrating various steps of the training method of FIG. 9, in accordance with some embodiments.

### DETAILED DESCRIPTION

This description of the example embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically connected (e.g., wired, wireless, etc.) to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein may be assigned to the other claimed objects and vice versa. In other words, claims for the systems may be improved with features described or claimed in the context of the methods. In this case, the functional features of the method are embodied by objective units of the systems. While the present disclosure is susceptible to various modifications and alternative forms, specific embodiments are shown by way of example in the drawings and will be described in detail herein. The objectives and advantages of the claimed subject matter will become more apparent from the following detailed description of these example embodiments in connection with the accompanying drawings.

Furthermore, in the following, various embodiments are described with respect to methods and systems for generating textual user interface elements. In various embodiments, a request to generate a textual user interface element for a selected interface element package is received. The request includes a plurality of targeted characteristics of the textual user interface element. In response to receiving the request, an input prompt based on first information derived from the plurality of targeted characteristics is generated. The initial textual user interface element based on first criteria is processed to generate a processed textual user interface element. At least the first criteria or the first information based on feedback information of the processed textual user interface element is modified. The textual user interface element based on the modified first criteria and/or the modified first information is generated.

In various embodiments, a system including a non-transitory memory and a processor communicatively coupled to the non-transitory memory. The processor receives a request to generate a textual user interface element for a selected interface element package. The request includes a plurality of targeted characteristics of the textual user interface element. In response to receiving the request, the processor generates an input prompt based on first information derived from the plurality of targeted characteristics; generate an initial textual user interface element using a pretrained large language model based on the input prompt; process the initial textual user interface element based on first criteria to generate a processed textual user interface element; modify at least the first criteria or the first information based on feedback information of the processed textual user interface element; and generate the textual user interface element based on the modified first criteria and/or the modified first information.

In various embodiments, a computer-implemented method is disclosed. The computer-implemented method includes steps of receiving a request to generate a textual user interface element for a selected interface element package, in response to receiving the request: generating an input prompt based on first information derived from the plurality of targeted characteristics; generating an initial textual user interface element using a pretrained model based on the input prompt; processing the initial textual user interface element based on first criteria to generate a processed textual user interface element; modifying at least the first criteria or the first information based on feedback information of the processed textual user interface element; and generating the textual user interface element based on the modified first criteria and/or the modified first information. The request includes a plurality of targeted characteristics of the textual user interface element.

In various embodiments, a non-transitory computer readable medium having instructions stored thereon is disclosed. The instructions, when executed by at least one processor, cause at least one device to perform operations including receiving a request to generate a textual user interface element for a selected interface element package; in response to receiving the request: generating an input prompt based on first information derived from the plurality of targeted characteristics; generating an initial textual user interface element using a pretrained model based on the input prompt; processing the initial textual user interface element based on first criteria to generate a processed textual user interface element; modifying at least the first criteria or the first information based on feedback information of the processed textual user interface element; and generating the textual user interface element based on the modified first criteria and/or the modified first information. The request includes a plurality of targeted characteristics of the textual user interface element.

In general, parameters of a trained function may be adapted by means of training. In particular, a combination of supervised training, semi-supervised training, unsupervised training, reinforcement learning and/or active learning may be used. Furthermore, representation learning (an alternative term is “feature learning”) may be used. In particular, the parameters of the trained functions may be adapted iteratively by several steps of training.

In some embodiments, a trained function may include a neural network, a support vector machine, a decision tree, a Bayesian network, a clustering network, Qlearning, genetic algorithms and/or association rules, and/or any other suitable artificial intelligence architecture. In some embodiments, a neural network may be a deep neural network, a convolutional neural network, a convolutional deep neural network, a transformer based network based on attention mechanism, etc. Furthermore, a neural network may be an adversarial network, a deep adversarial network, a generative adversarial network, etc.

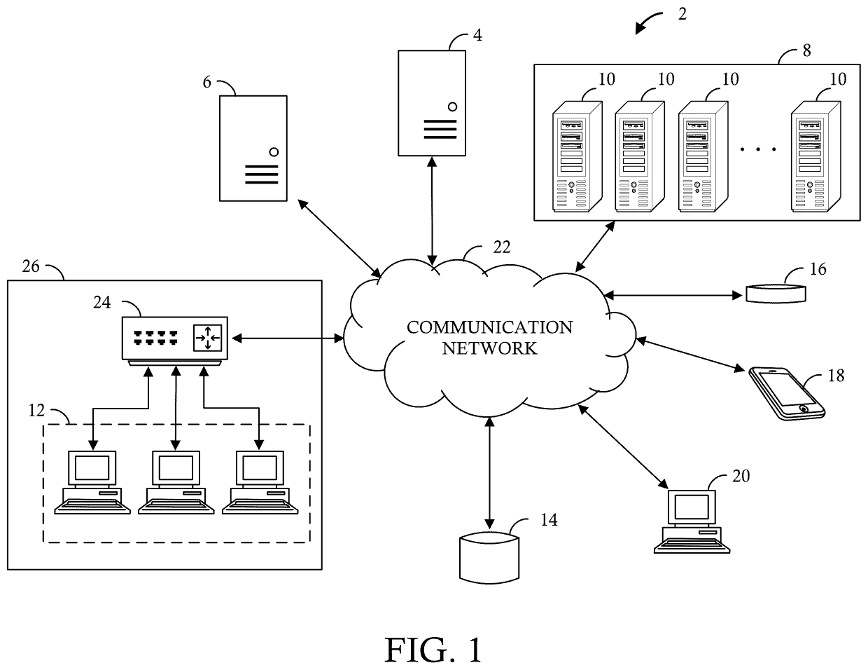

FIG. 1 illustrates a network environment 2 that provides automated textual user interface element generation, in accordance with some embodiments. The network environment 2 includes a plurality of devices or systems that communicates over one or more network channels, illustrated as a network cloud 22. For example, in various embodiments, the network environment 2 may include, but is not limited to, a textual user interface element generation computing device 4, a web server 6, a cloud-based engine 8 including one or more processing devices 10, workstation(s) 12, a database 14, and/or one or more user computing devices 16, 18, 20 operatively coupled over the network 22. The textual user interface element generation computing device 4, the web server 6, the processing device(s) 10, the workstation(s) 12, and/or the user computing devices 16, 18, 20 may each be a suitable computing device that includes any hardware or hardware and software combination for processing and handling information. For example, each computing device may include, but is not limited to, one or more processors, one or more field-programmable gate arrays (FPGAs), one or more application-specific integrated circuits (ASICs), one or more state machines, digital circuitry, and/or any other suitable circuitry. In addition, each computing device may transmit and receive data over the communication network 22.

In some embodiments, each of the textual user interface element generation computing device 4 and the processing device(s) 10 may be a computer, a workstation, a laptop, a server such as a cloud-based server, or any other suitable device. In some embodiments, each of the processing devices 10 is a server that includes one or more processing units, such as one or more graphical processing units (GPUs), one or more central processing units (CPUs), and/or one or more processing cores. Each processing device 10 may, in some embodiments, execute one or more virtual machines. In some embodiments, processing resources (e.g., capabilities) of the one or more processing devices 10 are offered as a cloud-based service (e.g., cloud computing). For example, the cloud-based engine 8 may offer computing and storage resources of the one or more processing devices 10 to the textual user interface element generation computing device 4.

In some embodiments, each of the user computing devices 16, 18, 20 may be a cellular phone, a smart phone, a tablet, a personal assistant device, a voice assistant device, a digital assistant, a laptop, a computer, or any other suitable device. In some embodiments, the web server 6 hosts one or more network environments, such as an e-commerce network environment or a textual user interface element generation environment. In some embodiments, the textual user interface element generation computing device 4, the processing devices 10, and/or the web server 6 are operated by the network environment provider, and workstation(s) 12 and/or the user computing devices 16, 18, 20 are operated by users of the network environment. In some embodiments, the processing devices 10 are operated by a third party (e.g., a cloud-computing provider).

The workstation(s) 12 are operably coupled to the communication network 22 via a router (or switch) 24. The workstation(s) 12 and/or the router 24 may be located at a physical location 26 remote from the textual user interface element generation computing device 4, for example. The workstation(s) 12 may communicate with the textual user interface element generation computing device 4 over the communication network 22. The workstation(s) 12 may send data to, and receive data from, the textual user interface element generation computing device 4. For example, the workstation(s) 12 may transmit data related to user interface element packages selected for textual user interface generation, for example, user interface element package data structures.

Although FIG. 1 illustrates three user computing devices 16, 18, 20, the network environment 2 may include any number of user computing devices 16, 18, 20. Similarly, the network environment 2 may include any number of the textual user interface element generation computing device 4, the web server 6, the processing devices 10, the workstation(s) 12, and/or the databases 14. It will further be appreciated that additional systems, servers, storage mechanism, etc. may be included within the network environment 2. In addition, although embodiments are illustrated herein having individual, discrete systems, it will be appreciated that, in some embodiments, one or more systems may be combined into a single logical and/or physical system. For example, in various embodiments, one or more of the textual user interface element generation computing device 4, the web server 6, the workstation(s) 12, the database 14, the user computing devices 16, 18, 20, and/or the router 24 may be combined into a single logical and/or physical system. Similarly, although embodiments are illustrated having a single instance of each device or system, it will be appreciated that additional instances of a device may be implemented within the network environment 2. In some embodiments, two or more systems may be operated on shared hardware in which each system operates as a separate, discrete system utilizing the shared hardware, for example, according to one or more virtualization schemes.

The communication network 22 may be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 22 may provide access to, for example, the Internet.

Each of the user computing devices 16, 18, and 20 may communicate with the web server 6 over the communication network 22. For example, each of the user computing devices 16, 18, 20 may be operable to view, access, and interact with a website, such as a textual user interface element generation website, hosted by the web server 6. The web server 6 may transmit user session data related to a user's activity (e.g., interactions) on the website. For example, a user may operate one of the user computing devices 16, 18, 20 to initiate a web browser that is directed to the website hosted by the web server 6. The user may, via the web browser, perform various operations such as searching one or more databases or catalogs associated with the displayed website, view item data for elements associated with and displayed on the website, and click on interface elements presented via the website, for example, in the search results. The website may capture these activities as user session data, and transmit the user session data to the textual user interface element generation computing device 4 over the communication network 22. The website may also allow the user to interact with one or more of interface elements to perform specific operations, such as selecting one or more items for further processing. In some embodiments, the web server 6 transmits user interaction data identifying interactions between the user and the website to the textual user interface element generation computing device 4.

In some embodiments, the textual user interface element generation computing device 4 may execute one or more models, processes, or algorithms, such as a machine learning model, deep learning model, statistical model, etc., to generate textual user interface elements that corresponds to a selected user interface element package. The textual user interface element generation computing device 4 may receive a textual element generation request from the web server 6 over the communication network 22. For example, the web server 6 may display interface elements associated with a characteristics selection interface that receives identification of features, constraints, characteristics and/or other inputs to allow generation of textual user interface elements by the textual user interface element generation computing device.

The textual user interface element generation computing device 4 is further operable to communicate with the database 14 over the communication network 22. For example, the textual user interface element generation computing device 4 may store data to, and read data from, the database 14. The database 14 may be a remote storage device, such as a cloud-based server, a disk (e.g., a hard disk), a memory device on another application server, a networked computer, or any other suitable remote storage. Although shown remote to the textual user interface element generation computing device 4, in some embodiments, the database 14 may be a local storage device, such as a hard drive, a non-volatile memory, or a USB stick. The textual user interface element generation computing device 4 may store interaction data received from the web server 6 in the database 14. The textual user interface element generation computing device 4 may also receive from the web server 6 user session data identifying events associated with browsing sessions, and may store the user session data in the database 14.

The models, when executed by the textual user interface element generation computing device 4, allow the textual user interface element generation computing device 4 to generate textual user interface elements for a user interface element package (e.g., a banner, or other content items, etc.). For example, the textual user interface element generation computing device 4 may obtain one or more models from the database 14. The textual user interface element generation computing device 4 may then receive, in real-time from the web server 6, a textual user interface element generation request. In response to receiving the textual user interface element generation request, the textual user interface element generation computing device 4 may execute one or more models to generate the textual user interface element.

In some embodiments, the textual user interface element generation computing device 4 assigns the models (or parts thereof) for execution to one or more processing devices 10. For example, each model may be assigned to a virtual machine hosted by a processing device 10. The virtual machine may cause the models or parts thereof to execute on one or more processing units such as GPUs. In some embodiments, the virtual machines assign each model (or part thereof) among a plurality of processing units. Based on the output of the models, textual user interface element generation computing device 4 may generate textual user interface elements that can be integrated into a contextually appropriate user interface element package that may include a graphical user interface element.

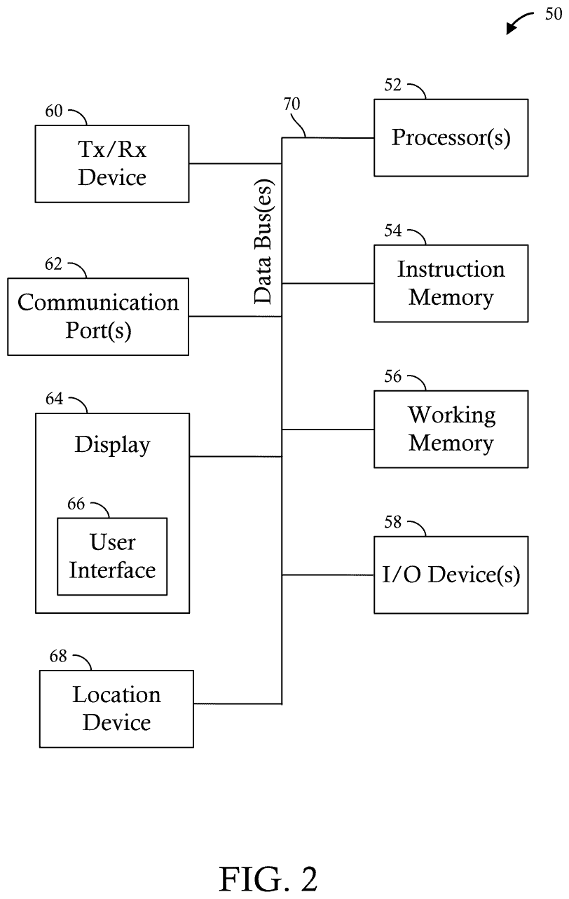

FIG. 2 illustrates a block diagram of a computing device 50, in accordance with some embodiments. In some embodiments, each of the textual user interface element generation computing device 4, the web server 6, the one or more processing devices 10, the workstation(s) 12, and/or the user computing devices 16, 18, 20 in FIG. 1 may include the features shown in FIG. 2. Although FIG. 2 is described with respect to certain components shown therein, it will be appreciated that the elements of the computing device 50 may be combined, omitted, and/or replicated. In addition, it will be appreciated that additional elements other than those illustrated in FIG. 2 may be added to the computing device.

As shown in FIG. 2, the computing device 50 may include one or more processors 52, an instruction memory 54, a working memory 56, one or more input/output devices 58, a transceiver 60, one or more communication ports 62, a display 64 with a user interface 66, and an optional location device 68, all operatively coupled to one or more data buses 70. The data buses 70 allow for communication among the various components. The data buses 70 may include wired, or wireless, communication channels.

The one or more processors 52 may include any processing circuitry operable to control operations of the computing device 50. In some embodiments, the one or more processors 52 include one or more distinct processors, each having one or more cores (e.g., processing circuits). Each of the distinct processors may have the same or different structure. The one or more processors 52 may include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 52 may also be implemented by a controller, a microcontroller, an application specific integrated circuit (ASIC), a field programmable gate array (FPGA), a programmable logic device (PLD), etc.

In some embodiments, the one or more processors 52 implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 54 may store instructions that are accessed (e.g., read) and executed by at least one of the one or more processors 52. For example, the instruction memory 54 may be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 52 may perform a certain function or operation by executing code, stored on the instruction memory 54, embodying the function or operation. For example, the one or more processors 52 may execute code stored in the instruction memory 54 to perform one or more of any function, method, or operation disclosed herein.

Additionally, the one or more processors 52 may store data to, and read data from, the working memory 56. For example, the one or more processors 52 may store a working set of instructions to the working memory 56, such as instructions loaded from the instruction memory 54. The one or more processors 52 may also use the working memory 56 to store dynamic data created during one or more operations. The working memory 56 may include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 54 and working memory 56, it will be appreciated that the computing device 50 may include a single memory unit that operates as both instruction memory and working memory. Further, although embodiments are discussed herein including non-volatile memory, it will be appreciated that computing device 50 may include volatile memory components in addition to at least one non-volatile memory component.

In some embodiments, the instruction memory 54 and/or the working memory 56 includes an instruction set, in the form of a file for executing various methods, such as methods for automated textual user interface element generation, as described herein. The instruction set may be stored in any acceptable form of machine-readable instructions, including source code or various appropriate programming languages. Some examples of programming languages that may be used to store the instruction set include, but are not limited to: Java, JavaScript, C, C++, C#, Python, Objective-C, Visual Basic, .NET, HTML, CSS, SQL, NoSQL, Rust, Perl, etc. In some embodiments, a compiler or interpreter converts the instruction set into machine executable code for execution by the one or more processors 52.

The input-output devices 58 may include any suitable device that allows for data input or output. For example, the input-output devices 58 may include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 60 and/or the communication port(s) 62 allow for communication with a network, such as the communication network 22 of FIG. 1. For example, if the communication network 22 of FIG. 1 is a cellular network, the transceiver 60 allows communications with the cellular network. In some embodiments, the transceiver 60 is selected based on the type of the communication network 22 the computing device 50 will be operating in. The one or more processors 52 are operable to receive data from, or send data to, a network, such as the communication network 22 of FIG. 1, via the transceiver 60.

The communication port(s) 62 may include any suitable hardware, software, and/or combination of hardware and software that is capable of coupling the computing device 50 to one or more networks and/or additional devices. The communication port(s) 62 may be arranged to operate with any suitable technique for controlling information signals using a desired set of communications protocols, services, or operating procedures. The communication port(s) 62 may include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 62 allows for the programming of executable instructions in the instruction memory 54. In some embodiments, the communication port(s) 62 allow for the transfer (e.g., uploading or downloading) of data, such as machine learning model training data.

In some embodiments, the communication port(s) 62 couple the computing device 50 to a network. The network may include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments may include in-body communications, various devices, and various modes of communications such as wireless communications, wired communications, and combinations of the same.

In some embodiments, the transceiver 60 and/or the communication port(s) 62 utilize one or more communication protocols. Examples of wired protocols may include, but are not limited to, Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols may include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 64 may be any suitable display, and may display the user interface 66. The user interfaces 66 may enable user interaction with automated textual user interface element generation. For example, the user interface 66 may be a user interface for an application of a network environment operator that allows a user to view and interact with the operator's website. In some embodiments, a user may interact with the user interface 66 by engaging the input-output devices 58. In some embodiments, the display 64 may be a touchscreen, where the user interface 66 is displayed on the touchscreen.

The display 64 may include a screen such as, for example, a Liquid Crystal Display (LCD) screen, a light-emitting diode (LED) screen, an organic LED (OLED) screen, a movable display, a projection, etc. In some embodiments, the display 64 may include a coder/decoder, also known as Codecs, to convert digital media data into analog signals. For example, the visual peripheral output device may include video Codecs, audio Codecs, or any other suitable type of Codec.

The optional location device 68 may be communicatively coupled to a location network and operable to receive position data from the location network. For example, in some embodiments, the location device 68 includes a GPS device that receives position data identifying a latitude and longitude from one or more satellites of a GPS constellation. As another example, in some embodiments, the location device 68 is a cellular device that receives location data from one or more localized cellular towers. Based on the position data, the computing device 50 may determine a local geographical area (e.g., town, city, state, etc.) of its position.

In some embodiments, the computing device 50 implements one or more modules or engines, each of which is constructed, programmed, configured, or otherwise adapted, to autonomously carry out a function or set of functions. A module/engine may include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine may also be implemented as a combination of the two, with certain functions facilitated by hardware alone, and other functions facilitated by a combination of hardware and software. In certain implementations, at least a portion, and in some cases, all, of a module/engine may be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine may be realized in a variety of physically realizable configurations, and should generally not be limited to any particular implementation exemplified herein, unless such limitations are expressly called out. In addition, a module/engine may itself be composed of more than one sub-modules or sub-engines, each of which may be regarded as a module/engine in its own right. Moreover, in the embodiments described herein, each of the various modules/engines corresponds to a defined autonomous functionality; however, it should be understood that in other contemplated embodiments, each functionality may be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

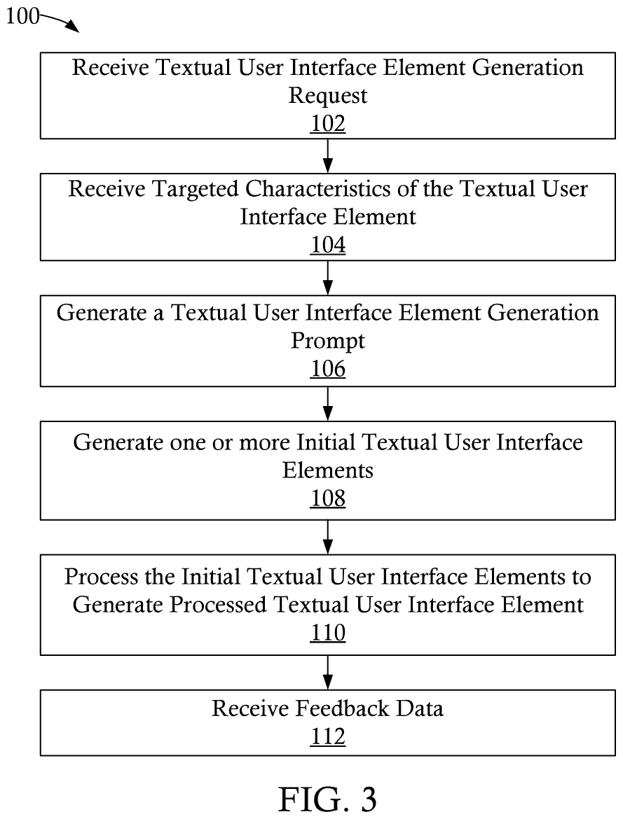

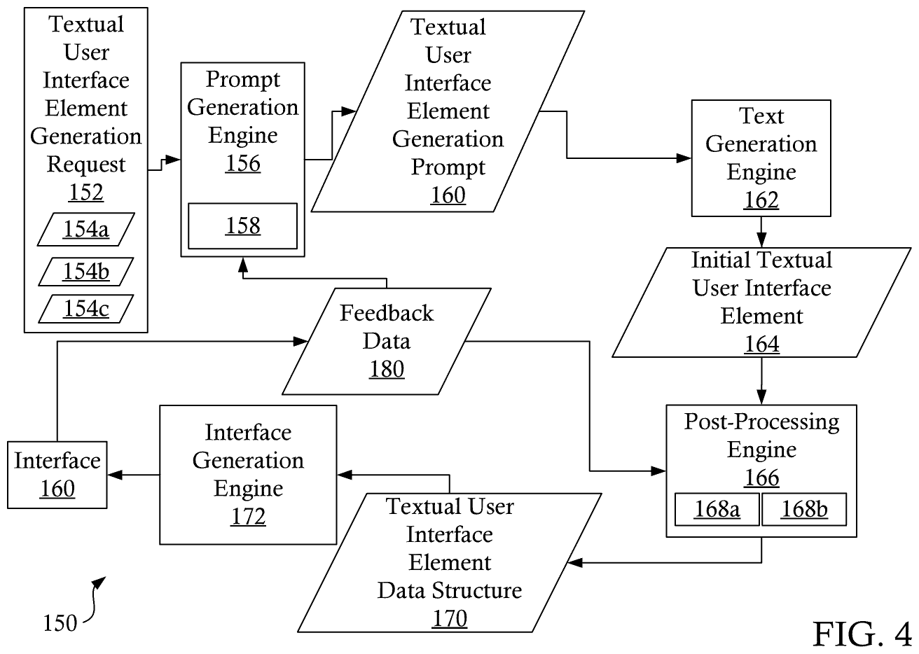

FIG. 3 is a flowchart illustrating a textual user interface element generation method 100, in accordance with some embodiments. FIG. 4 is a process flow 150 illustrating various steps of the textual user interface element generation method 100, in accordance with some embodiments. At step 102, a textual user interface element generation request 152 is received. At step 104, information about targeted characteristics of the textual user interface element is received. For example, the textual user interface element generation request 152 may include information about one or more targeted characteristics for which one or more textual user interface element data structures 170 are to be generated. In some embodiments, the targeted characteristics corresponds to various constraints and requirements placed on the textual user interface element, as described in detail below. The textual user interface element generation request 152 may be generated by any suitable system, such as, for example, a user system 16, 18, 20.

In some embodiments, the textual user interface element generation request 152 includes one or more identifiers (e.g., a first identifier 154a, a second identifier 154b, a third identifier 154c, etc.) that identify one or more target characteristics for the one or more textual user interface element data structures 170. The textual user interface element data structures 170 may be associated with a network environment. For example, in the context of an ecommerce environment, the first identifier 154a may include an item identifier that identifies an item or a group of items (e.g., item category, item brand, etc.) included in an item catalog associated with the ecommerce environment. The first identifier 154a may also include a program identifier that identifies a program (e.g., a subscription program, a benefits program, etc.) associated with the ecommerce environment. The first identifier 154a may include a season identifier that identifies a season (e.g., Christmas, Thanksgiving, Valentine's Day, Mother's Day, etc.) associated with the textual user interface element. Similarly, in the context of the ecommerce environment, the second identifier 154b may include user session data identifying events associated with browsing sessions and/or information about persona (e.g., auto enthusiast, busy family, pet parent, new parent, fashion, beauty (male), beauty (female), etc.) of a user to whom the textual user interface element is to be presented. The third identifier 154c may include a system identifier that identifies a style for the textual user interface element. Examples of styles include simple direct messaging, simple direct messaging that includes characteristics of an item (e.g., a brand of an item, a specific item title, etc.), rhetorical questions, from X to Y (e.g., from item A to item B within a specific brand, etc.), messages that do not mention a specific program (e.g., a benefits program) associated with the ecommerce environment, etc. Although specific embodiments are discussed herein, it will be appreciated that the first identifier 154a, the second identifier 154b, and the third identifier 154c, may identify any suitable element for generation of a textual user interface element data structure 170, as disclosed herein.

In some embodiments, the first identifier 154a, the second identifier 154b, and the third identifier 154c are reframed as constraints on the textual user interface element and provided together with the textual user interface element generation request 152 to align a large language model (LLM) with a specific use case. For example, these constraints may define a set of targeted characteristics of the textual user interface element. Examples of constraints include numerical constraints such as the maximum number of characters or the number of words allowed in the textual user interface element, content constraints such as sentiment constraint, keyword constraint, topic constraint, style constraint, etc., and/or any other suitable constraint.

Examples of sentiment constraints include, but are not limited to, requiring the textual user interface element to be a positive message, a neutral message, or messages that create excitement. In general, a sentiment in message contained in the textual user interface element aligns with characteristics of the ecommerce environment (e.g., brand voice, etc.). Examples of keyword constraints include, but are not limited to, the keywords that describe a program (e.g., subscription program, a benefits program, etc.) associated with the ecommerce environment, such as “free delivery from store,” “free shipping no order minimum,” the benefit name itself or approved words corresponding to the benefit or equivalents. Keywords in the keyword constraint may reflect value proposition associated with the textual user interface element. Topic constraints may include the elements of the third identifier 154c, such as the season, or elements of the second identifier 154b, such as persona, or elements of the first identifier 154a, such as item identifiers that identify items or groups of items (e.g., item category, or item brand) included in the item catalog associated with the ecommerce environment. For example, in some embodiments, the first identifier 154a may be utilized to retrieve data associated with an element or item from a data store, such as database 14. Style constraints include the specification of, for example, whether the message should be in the form of simple direct messaging, rhetorical questions, or from X to Y, etc.

At step 106, a textual user interface element generation prompt 160 (e.g., an input prompt) is automatically generated by a prompt generation engine 156 based on the textual user interface element generation request 152 and one or more of the first identifier 154a, the second identifier 154b, and the third identifier 154c. The textual user interface element generation prompt 160 may include natural language text, formatted text, sets of descriptions, and/or any other suitable text format. The textual user interface element generation prompt 160 is generated in a style that may be received by a text generation engine 162 (e.g., that is communicatively connected to a large language model (LLM), as described in greater detail below). In some embodiments, a system prompt is further included in the textual user interface element generation prompt 160. The system prompt may provide general instructions to the LLM. For example, the system prompt may be used to assign a persona to the LLM, such as a role to play when generating an output, such as “Act as a graduate teaching assistant,” “You are a creative advertising writer,” “You are a helpful, respectful and honest assistant,” etc. The system prompt may be appended to the instructions such as “generate messages for users who are auto enthusiasts.”

The prompt generation engine 156 includes an in-context learning module 158. In-context learning refers to, for example, providing a text input (e.g., a prompt) to a large language model (LLM) for task specification. The LLM may be conditioned on such instructions and/or on a few demonstrations (examples) of the task provided in the prompt. Examples of in-context learning include: zero-shot learning, one-shot learning, and few-shot learning. In some embodiments, the in-context learning module 158 generates the textual user interface element generation prompt 160 using one of zero-shot learning, one-shot learning, or few-shot learning.

In zero-shot learning, sample messages (e.g., corresponding to an output, such as a desired output, of the textual user interface element generation request 152) are not provided. An example of such a prompt includes “generate 10 different messages for users who are auto enthusiasts. Each message should be strictly under 15 words.” In one-shot learning, a sample message is provided in the prompt (e.g., the textual user interface element generation prompt 160). For example, one-shot learning prompt may include instructions to “paraphrase the following message in 8-10 words in 10 different creative ways: Buy gadgets and get free shipping even on orders under $35.” In few-shot learning, two or more sample messages are included in the prompt.

At step 108, a model (e.g., one or more LLMs such as GPT-3.5, GPT-4, LLAMA-2, etc.) that are in communication with a text generation engine 162 (e.g., via an API call, is a part of the text generation engine 162, etc.) generate one or more initial textual elements 164 based on the textual user interface element generation prompt 160. An example of initial textual elements 164 may include “Spread holiday cheer with Benefits Program One. Free Shipping-no minimum purchase required for toys and games! Make your Christmas shopping merrier with Benefits Program One free shipping, no minimum order required!” This initial textual element may have exceeded the word limit and may be truncated via post-processing (e.g., via step 110, etc.). Another example of initial textual elements 164 may include “Why wait for Santa when Benefits Program One has free shipping with no minimum?” This initial textual element may not have conformed with requirements set forth in one or more identifiers (e.g., a first identifier 154a, a second identifier 154b, a third identifier 154c, etc.) specifying one or more target characteristics for the one or more textual user interface element data structures 170. For example, the style specified in one of the identifiers may have required the style of “from X to Y,” instead of a rhetorical question. In such a scenario, the initial textual elements 164 of “Want to build a world of fun with Item One? Get free shipping on Benefits Program One, no minimum order required!” may be approved (e.g., without changes, etc.) during post-processing (e.g., via step 110, etc.)

At step 110, the one or more initial textual elements 164 are processed by a post-processing engine 166 to generate a processed textual user interface element that is part of textual user interface element data structure 170. The post-processing engine 166 identifies issues from the one or more initial textual element 164, for example, when the LLM fails to follow all the instructions provided in the textual user interface element generation prompt 160. The post-processing engine 166 eliminates and/or corrects mistakes in the initial textual elements 164 by performing cleaning, filtering, ranking, etc. of the one or more initial textual elements 164. Some examples of tasks performed by the post-processing engine 166 include, but are not limited to, removing emojis, checking guidelines, checking the style of message, etc. The post-processing engine 166 may include, for example, a rule-based module 168a and an LLM-based module 168b for checking the one or more initial textual elements 164 (e.g., whether the one or more initial textual elements 164 satisfy first criteria). The rule-based module 168a may include a number of determinations (e.g., via decision trees, binary classifications, etc.) to check if the one or more initial textual elements 164 meet a predefined set of rules (e.g., messages should not contain emojis, messages should meet word and/or character limits, etc.). The LLM-based module 168b accesses an LLM (e.g., via an API call) to check if the one or more initial textual elements 164 meet one or more criterion (e.g., whether the one or more initial textual elements 164 satisfy a desired style and/or meet responsible AI commitments). The LLM-based module 168b does not require a predefined set of rules to be provided to the post-processing engine 166. The post-processing engine 166 may also flag one or more initial textual elements 164 to be checked manually.

In some embodiments, one or more filtering and/or review processes may be implemented at various stages to identify and/or prevent generation of undesirable textual content. For example, one or more filtering processes may be applied to identify, remove, and/or otherwise eliminate undesirable content such as inappropriate texts, offensive texts, restricted texts, etc. Filtering may occur at any suitable stage of the textual user interface element generation process, such as, for example, one or more of step 108, 110, etc. Although specific embodiments are discussed herein, it will be appreciated that any suitable filtering may applied at any suitable steps of the disclosed methods.

Textual user interface element data structure 170 is the processed output from the post-processing engine 166 (e.g., after initial textual elements are processed). An interface generation engine 172 then presents the textual interface element data structure 170 on an interface 174. For example, the interface 174 is presented on one of the user computing devices 16, 18, 20 via an application user interface that receives, as input, the textual interface element data structure 170. The interface 174 may also be presented via a web browser that is directed to a website (e.g., intranet) hosted by a web server which receives and stores textual interface element data structure 170. The interface 174 may also allow the user to interact with one or more of textual user interface elements to perform specific operations, such as selecting one or more textual user interface elements for further processing. In some embodiments, the interface 174 also displays other previously approved textual user interface elements and/or previously rejected textual user interface elements. The user may, via the interface 174, perform various operations such viewing, selecting, and searching for previously approved textual user interface elements. The interface 174 may capture these activities as user session data, and transmit the user session data to the textual user interface element generation computing device 4 over the communication network 22.

At step 112, feedback data 180 is received. Authorized personnel (e.g., from a marketing team, other supervisory groups, etc.) provide feedback data 180 by approving or disapproving the messages contained in the textual user interface element data structure 170. Feedback data 180 may include data representative of interactions and/or rankings of one or more of the outputs (e.g., textual user interface element), included in one or more textual user interface element data structures 170. The feedback data 180 may include direct feedback and/or indirect feedback. In some embodiments, the feedback data 180 includes positive and/or negative feedback related to the one or more outputs, such as the textual user interface element. In one non-limiting example, negative feedback may include an indication to remove an element from the textual user interface element, e.g., “avoid in-store shopping” As another non-limiting example, positive feedback may include an indication to add or change an element in the textual user interface element. Although specific embodiments are discussed herein, it will be appreciated that the feedback data 180 may include any suitable feedback, including natural language feedback. The feedback data 180 may be used to revise one or more of the generated outputs (e.g., textual user interface element generation prompt 160, textual user interface element data structure 170, etc.). The feedback data 180 is provided to the post-processing engine 166 to improve the rule-based module 168a (e.g., if the previously processed output from the post-processing engine 166 contained errors or undesired characteristics that can be eliminated based on one or more rules) and/or the LLM-based module 168b (e.g., based on in-context learning, for example, one-shot or few-shot learning using messages that are rejected by the authorized personnel via the interface 174). The feedback data 180 may also be provided to the prompt generation engine 156 to improve the in-context learning module 158. For example, improving one-shot or few-shot learning using messages that are approved by the authorized personnel via the interface 174 to generate better textual user interface element generation prompts that would yield messages that are more likely to be approved by the authorized personnel. In some embodiments, the approved messages are stored in a database as possible textual user interface elements that may be presented to a user. For example, a diverse set of messages may be generated for any combination of input features in near real time.

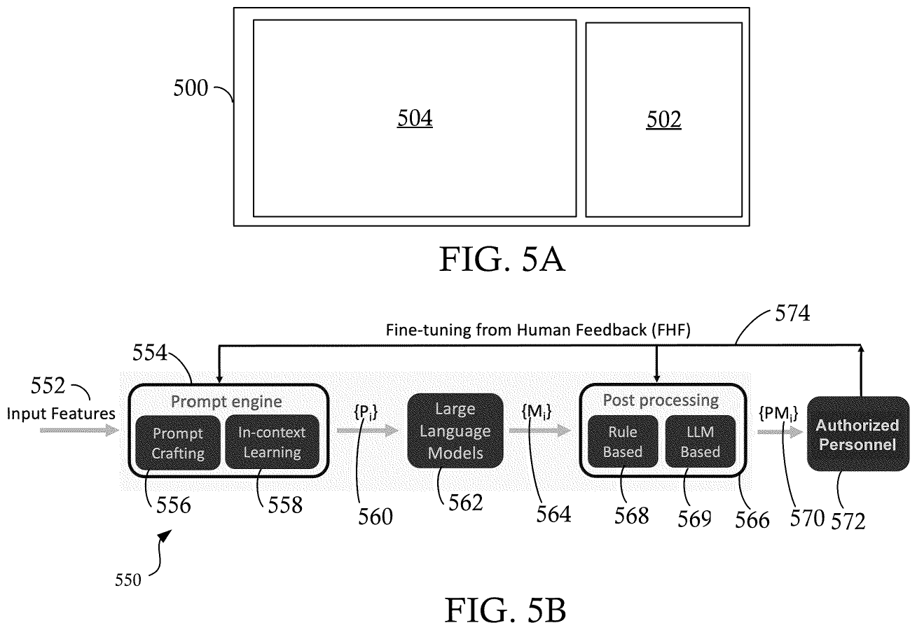

FIG. 5A illustrates an example interface element package, in accordance with some embodiments. An interface element package 500 includes a textual user interface element 504 and a graphical user interface element 502. The graphical user interface element 502 may include an image, an animated image file, or a video clip. The interface element package 500 may be a banner, carousel, and/or other content elements that include items or content relevant to the ecommerce environment. The textual user interface element data structure 170 generated in process flow 150 may be rendered by computing devices 16, 18, 20 and displayed as textual user interface element 504. The relative sizes, shapes, and positions of textual user interface element 504 and the graphical user interface element 502 may be different from the example illustrated in FIG. 5A. For example, the textual user interface element 504 may be smaller in size than the graphical user interface element 502, and maybe overlaid on the graphical user interface element 502. Meta information, such as features and constraints associated with the graphical user interface element 502 may be used to generate a better matched textual user interface element 504.

FIG. 5B shows a process flow, in accordance with some embodiments. A process flow 550 begins when input features 552, such as the constraints and specifications (e.g., the first identifier 154a, the second identifier 154b, the third identifier 154c, etc.) are provided to a prompt engine 554. The prompt engine 554 (e.g., similar to the prompt generation engine 156 described with reference to FIGS. 3-4) includes a prompt crafting engine 556 and an in-context learning module 558 (e.g., similar to the in-context learning module 246 described with reference to FIG. 3 and FIG. 4). The prompt engine 554 generates output 560, which includes one or more prompts Pᵢ, provided as input to LLM 562 to specify a task, such as generating textual user interface elements (hereinafter also sometimes referred to as “messages”). LLM 562 is, for example, communicatively connected (e.g., via API calls) with the text generation engine 162 described with reference to FIGS. 3-4. The LLM 562 generates output 564, which includes one or more initial textual elements Mᵢ (e.g., similar to the initial textual element 164 described with reference to FIGS. 3-4). The one or more initial textual elements Mᵢ are provided to a post-processing module 566 (e.g., similar to the post-processing engine 166 described with reference to FIGS. 3-4) to undergo rule-based, and LLM-based, post-processing via rule-based module 568 and LLM-based module 569, respectively (e.g., similar to the rule-based module 168a and the LLM-based module 168b described with reference to FIGS. 3-4). The post-processing module 566 outputs the processed textual user interface element PMᵢ as textual user interface element data structure 170 to authorized personnel for approval. In some embodiments, both the prompt and the message generated by the prompt are provided to the authorized personnel. Feedback 574 from the authorized personnel is fed back to the prompt engine 554 to improve the quality of prompts generated, and to the post-processing module 566 to improve the post-processing procedures, for example, as a part of fine-tuning from human feedback (FHF).

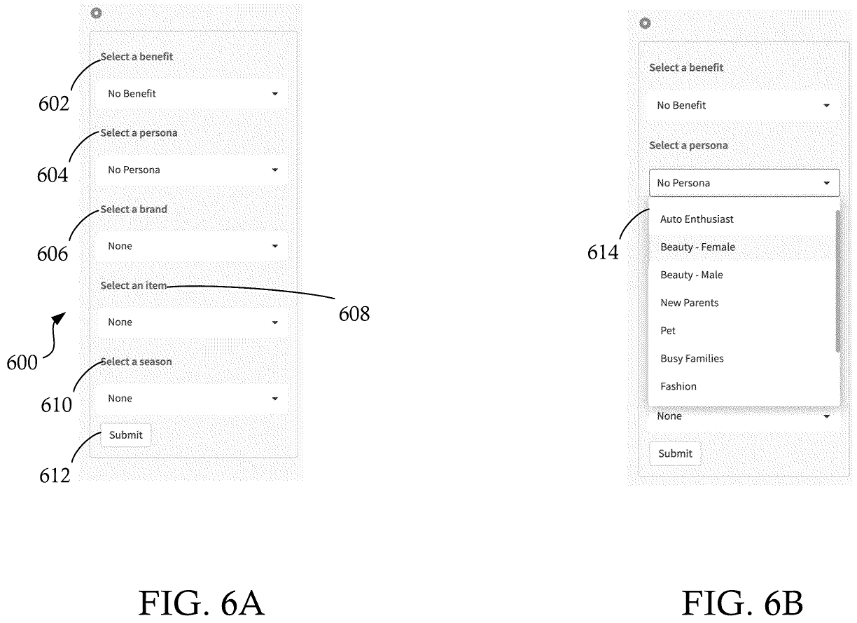

FIGS. 6A and 6B show example user interfaces, in accordance with some embodiments. A user interface 600 allows a user to select specific constraints for the textual user interface element. In some embodiments, the user interface 600 may be provided to generate the textual user interface element generation request 152. For example, a benefit program field 602 allows specific features of a benefit program (e.g., a subscription program) to be targeted in the textual user interface element. Similarly, a persona field 604 allows a specific persona (e.g., as shown in a drop-down menu 614) to be selected so that the textual user interface element may be more relevant to a user matching the specified persona. A brand field 606 allows a specific brand to be selected so that the textual user interface element may be targeted for an item of a specified brand. An item field 608 allows a specific item to be selected for (e.g., is the target of) the textual user interface element generation method 100 so that the textual user interface element may be targeted for the specified item. A season field 610 allows a specific season (e.g., Christmas, Thanksgiving, Valentine's Day, Mother's Day, etc.) to be selected so that the textual user interface element may be targeted for the specified season, as described in reference to the first identifier 154a and topic constraint described above. The selected fields may be interpreted as one or more of the first identifier 154a, the second identifier 154b, and/or the third identifier 154c. For example, a user (e.g., authorized personnel) may select one option from one or more of the benefit program field 602, persona field 604, brand field 606, item field 608, and season field 610 before selecting a submit button 612 to generate the textual user interface element generation request 152.

Manual generation of context-appropriate textual user interface elements for a variety of content items, such as banners, that change with time is burdensome and time consuming. Textual user interface element package generation systems and methods as disclosed herein significantly reduce this problem, allowing automated generation of context-appropriate textual user interface elements. For example, in some embodiments described herein, a user identifies one or more of an item, a brand, a feature of a benefits program, a season, and a persona, for example via an input, and context-appropriate textual user interface elements are automatically generated for the request. Beneficially, programmatically generating textual user interface elements eliminates the requirement to manually generate textual user interface elements that correspond to these time-varying and vast numbers of content items (e.g., banners, etc.), allowing generation of context-appropriate textual user interface element by any authorized personnel interacting with the network environment. The textual user interface elements may be personalized to users of respective computing devices, and may increase user engagement and enrich the user's experience. For example, messages that users see may change based on their recent activities. The textual user interface element package generation systems and methods as disclosed herein may be scaled to a large set of features (e.g., benefits program, persona, brand, item, seasons, etc.) and applications (e.g., generate textual user interface elements for banners, for carousels, or other content items, etc.). The disclosed systems and methods may also be seamlessly integrated with existing engineering infrastructure to leverage capacities of existing systems. At the same time, the disclosed systems and methods are adaptable and may be able to update or replace the LLM model used for text generation with minimal effort. The textual user interface elements generated may be creative (e.g., not obvious, etc.), diverse and unique to the selected features (e.g., benefits program, persona, brand, item, seasons, etc.) and message style.

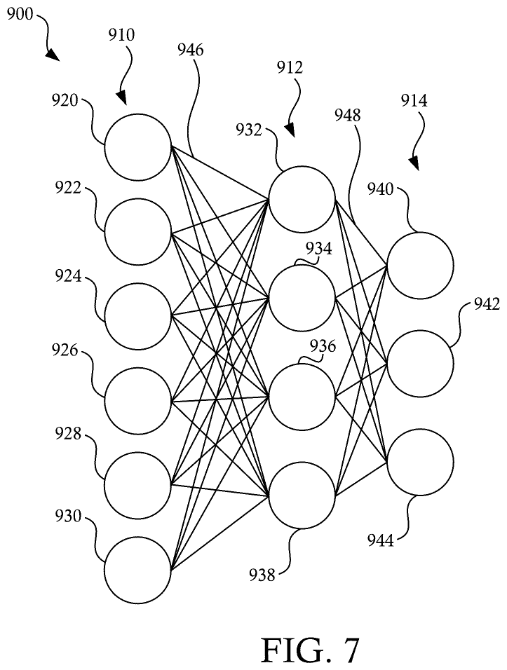

FIG. 7 illustrates an artificial neural network 900, in accordance with some embodiments. Alternative terms for “artificial neural network” are “neural network,” “artificial neural net,” “neural net,” or “trained function.” The neural network 900 comprises nodes 920-944 and edges 946-948, wherein each edge 946-948 is a directed connection from a first node 920-938 to a second node 932-944. In general, the first node 920-938 and the second node 932-944 are different nodes, although it is also possible that the first node 920-938 and the second node 932-944 are identical. For example, in FIG. 7 the edge 946 is a directed connection from the node 920 to the node 932, and the edge 948 is a directed connection from the node 932 to the node 940. An edge 946-948 from a first node 920-938 to a second node 932-944 is also denoted as “ingoing edge” for the second node 932-944 and as “outgoing edge” for the first node 920-938.

The nodes 920-944 of the neural network 900 may be arranged in layers 910-914, wherein the layers may comprise an intrinsic order introduced by the edges 946-948 between the nodes 920-944 such that edges 946-948 exist only between neighboring layers of nodes. In the illustrated embodiment, there is an input layer 910 comprising only nodes 920-930 without an incoming edge, an output layer 914 comprising only nodes 940-944 without outgoing edges, and a hidden layer 912 in-between the input layer 910 and the output layer 914. In general, the number of hidden layer 912 may be chosen arbitrarily and/or through training. The number of nodes 920-930 within the input layer 910 usually relates to the number of input values of the neural network, and the number of nodes 940-944 within the output layer 914 usually relates to the number of output values of the neural network.

In particular, a (real) number may be assigned as a value to every node 920-944 of the neural network 900. Here, xᵢ⁽ⁿ⁾ denotes the value of the i-th node 920-944 of the n-th layer 910-914. The values of the nodes 920-930 of the input layer 910 are equivalent to the input values of the neural network 900, the values of the nodes 940-944 of the output layer 914 are equivalent to the output value of the neural network 900. Furthermore, each edge 946-948 may comprise a weight being a real number, in particular, the weight is a real number within the interval [−1, 1], within the interval [0, 1], and/or within any other suitable interval. Here, w_{i,j}^{(m,n)} denotes the weight of the edge between the i-th node 920-938 of the m-th layer 910, 912 and the j-th node 932-944 of the n-th layer 912, 914. Furthermore, the abbreviation w_{i,j}⁽ⁿ⁾ is defined for the weight w_{i,j}^{(n,n+1)}.

In particular, to calculate the output values of the neural network 900, the input values are propagated through the neural network. In particular, the values of the nodes 932-944 of the (n+1)-th layer 912, 914 may be calculated based on the values of the nodes 920-938 of the n-th layer 910, 912 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 910 are given by the input of the neural network 900, wherein values of the hidden layer(s) 912 may be calculated based on the values of the input layer 910 of the neural network and/or based on the values of a prior hidden layer, etc.

In order to set the values w_{i,j}^{(m,n)} for the edges, the neural network 900 has to be trained using training data. In particular, training data comprises training input data and training output data. For a training step, the neural network 900 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 900 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ may be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 914, wherein f′ is the first derivative of the activation function, and tⱼ⁽ⁿ⁺¹⁾ is the comparison training value for the j-th node of the output layer 914.

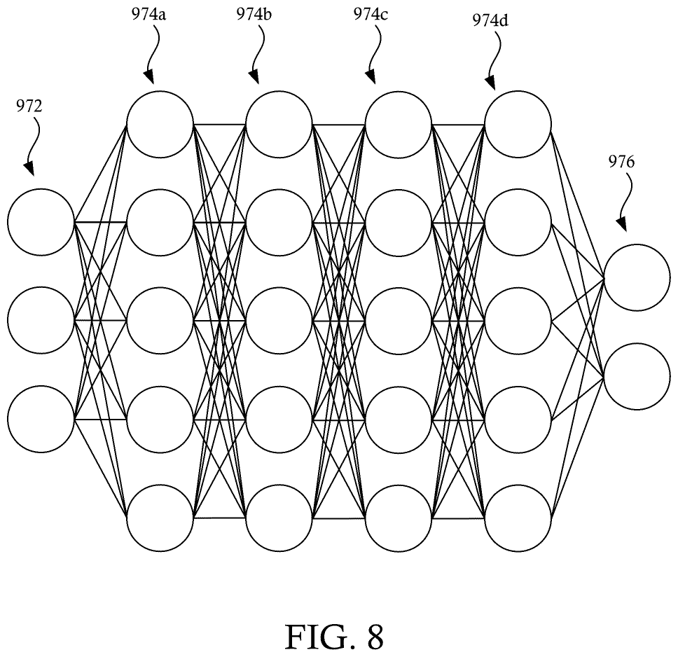

FIG. 8 illustrates a deep neural network (DNN) 970, in accordance with some embodiments. Alternative terms for “artificial neural network” are “neural network,” “artificial neural net,” “neural net,” or “trained function.” The DNN 970 is an artificial neural network, such as the neural network 900 illustrated in conjunction with FIG. 7, that includes representation learning. The DNN 970 may include an unbounded number of (e.g., two or more) intermediate layers 974a-974d each of a bounded size (e.g., having a predetermined number of nodes), providing for practical application and optimized implementation of a universal classifier. Each of the layers 974a-974d may be heterogenous. The DNN 970 may model complex, non-linear relationships. Intermediate layers, such as intermediate layer 974c, may provide compositions of features from lower layers, such as layers 974a, 974b, providing for modeling of complex data.

In some embodiments, the DNN 970 may be considered a stacked neural network including multiple layers that each executes one or more computations. The computation for a network with L hidden layers may be denoted as:

$$f ( i ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)} (x) is a preactivation function and h^{(l)}(x) is a hidden-layer activation function providing the output of each hidden layer. The preactivation function a₍ₗ₎(x) may include a linear operation with matrix W₍ₗ₎ and bias b^{(l)}, where:

$${a}^{( l )} ( x ) = {W}^{( l )} x + {b}^{( l )}$$

In some embodiments, the DNN 970 is a feedforward network in which data flows from an input layer 972 to an output layer 976 without looping back through any layers. In some embodiments, the DNN 970 may include a backpropagation network in which the output of at least one hidden layer is provided, e.g., propagated, to a prior hidden layer. The DNN 970 may include any suitable neural network, such as a self-organizing neural network, a recurrent neural network, a convolutional neural network, a modular neural network, and/or any other suitable neural network.

In some embodiments, a DNN 970 may include a neural additive model (NAM). An NAM includes a linear combination of networks, each of which attends to (e.g., provides a calculation regarding) a single input feature. For example, a NAM may be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 970 may include a neural multiplicative model (NMM), including a multiplicative form for the NAM mode using a log transformation of the dependent variable y and the independent variable x:

y=e^{β}e^{f(log x)}e^{Σ}^{ᵢ}^{f}^{ᵢ}^{^{d}}^{(d}^{ᵢ}⁾
where d represents one or more features of the independent variable x.

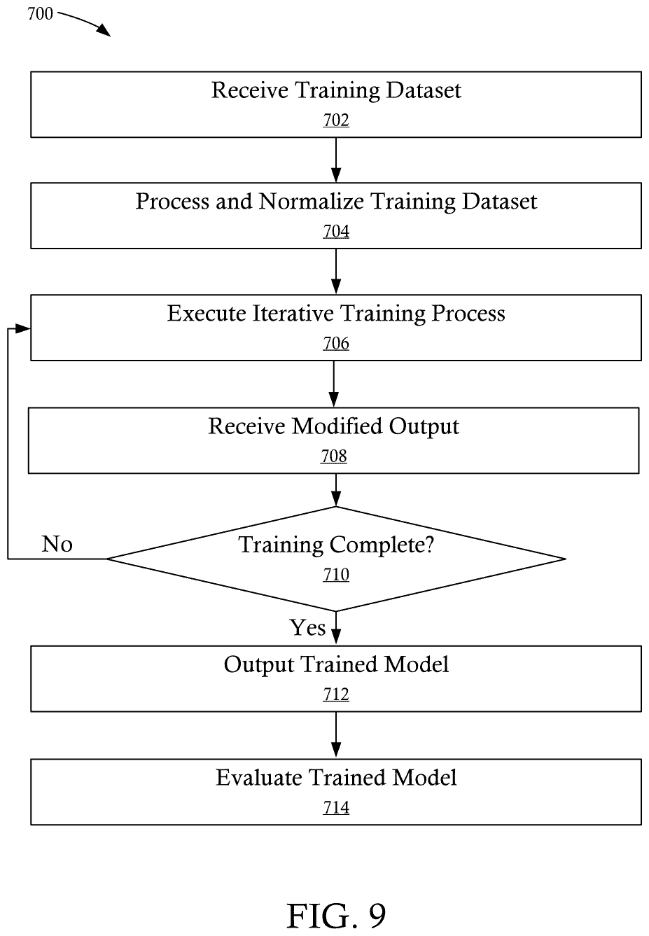

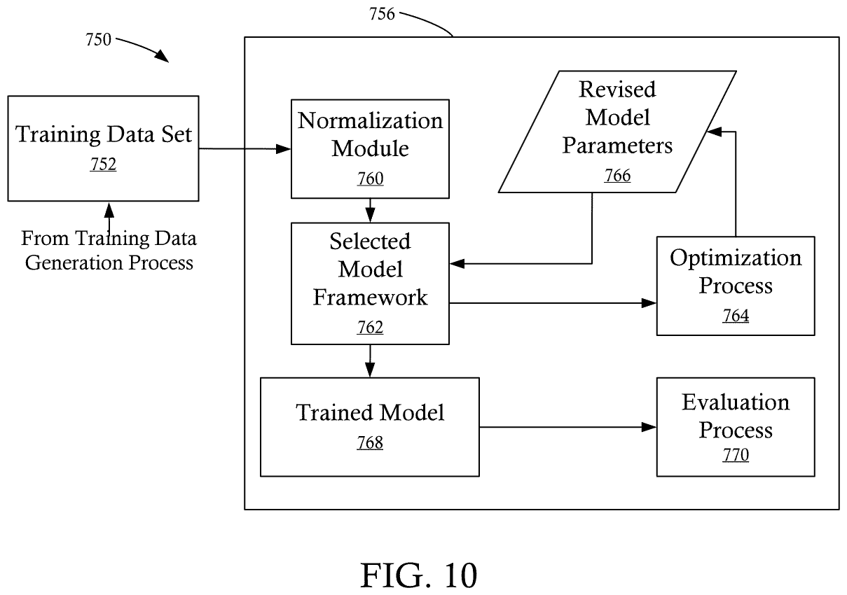

In some embodiments, one or more trained models can be generated using an iterative training process based on a training dataset. FIG. 9 illustrates a method 700 for generating a trained model, such as a trained optimization model, in accordance with some embodiments. FIG. 10 is a process flow 750 illustrating various steps of the method 700 of generating a trained model, in accordance with some embodiments. At step 702, a training dataset 752 is received by a system, such as a processing device 10. The training dataset 752 can include labeled and/or unlabeled data.

At optional step 704, the received training dataset 752 is processed and/or normalized by a normalization module 760. For example, in some embodiments, the training dataset 752 can be augmented by imputing or estimating missing values of one or more features. In some embodiments, processing of the received training dataset 752 includes outlier detection that removes data likely to skew training of a model. In some embodiments, processing of the received training dataset 752 includes removing features that have limited value with respect to training of a relevant model.

At step 706, an iterative training process is executed to train a selected model framework 762. The selected model framework 762 can include an untrained (e.g., base) machine learning model and/or a partially or previously trained model (e.g., a prior version of a trained model). The training process iteratively adjusts parameters (e.g., hyperparameters) of the selected model framework 762 to minimize a cost value (e.g., an output of a cost function) for the selected model framework 762.

The training process is an iterative process that generates a set of revised model parameters 766 during each iteration. The set of revised model parameters 766 can be generated by applying an optimization process 764 to the cost function of the selected model framework 762. The optimization process 764 can reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained model 768, is output and provided for use in one or more processes, such as a textual user interface element generation method 100 discussed above. At optional step 712, a trained model 768 can be evaluated by an evaluation process 770. A trained model can be evaluated based on any suitable metrics, such as, for example, an F or FI score, normalized discounted cumulative gain (NDCG) of the model, mean reciprocal rank (MRR), mean average precision (MAP) score of the model, and/or any other suitable evaluation metrics. Although specific embodiments are discussed herein, it will be appreciated that any suitable set of evaluation metrics can be used to evaluate a trained model.

Although the subject matter has been described in terms of example embodiments, it is not limited thereto. Rather, the appended claims should be construed broadly, to include other variants and embodiments, which may be made by those skilled in the art.

What is claimed is:

1. A system, comprising:
a processor; and
a non-transitory memory, storing instructions, that when executed, cause the processor to:
receive a request to generate a textual user interface element for a selected interface element package, wherein the request comprises a plurality of targeted characteristics of the textual user interface element;
in response to receiving the request:
generate an input prompt based on the plurality of targeted characteristics;
generate an initial textual user interface element using a pretrained model based on the input prompt;
process the initial textual user interface element based on first criteria to generate a processed textual user interface element;
modify at least the first criteria or the input prompt based on feedback information of the processed textual user interface element to generate a modified input; and
generate the textual user interface element based on the modified input.

2. The system of claim 1, wherein the pretrained model comprises a large language model, wherein the plurality of targeted characteristics of the textual user interface element are derived from one or more identifiers included in the request to generate the textual user interface element, and wherein the one or more identifiers are applied as constraints on the textual user interface element to align the large language model with a specific use case.

3. The system of claim 2, wherein the one or more identifiers include a system identifier that identifies a language style of the textual user interface element.

4. The system of claim 1, wherein processing the initial textual user interface element based on the first criteria to generate the processed textual user interface element comprises post-processing the initial textual user interface element using at least one of a rule-based process or an LLM-based process to determine whether the initial textual user interface element meets the first criteria.

5. The system of claim 1, wherein the instructions cause the processor to implement a user interface generator that receives the textual user interface element generated based on the modified input and displays the textual user interface element on an interface that enables user input.

6. The system of claim 1, wherein the instructions cause the processor to receive feedback data that generates input prompts based on approved textual user interface elements.

7. The system of claim 1, wherein the textual user interface element includes an approved message.

8. A computer-implemented method, comprising:
receiving a request to generate a textual user interface element for a selected interface element package, wherein the request comprises a plurality of targeted characteristics of the textual user interface element;
in response to receiving the request:
generating an input prompt based on the plurality of targeted characteristics;
generating an initial textual user interface element using a pretrained model based on the input prompt;
processing the initial textual user interface element based on first criteria to generate a processed textual user interface element;
modifying at least the first criteria or the input prompt based on feedback information of the processed textual user interface element to generate a modified input; and
generating the textual user interface element based on the modified input.

9. The method of claim 8, wherein the pretrained model comprises a large language model, wherein the plurality of targeted characteristics of the textual user interface element are derived from one or more identifiers included in the request to generate the textual user interface element, and wherein the one or more identifiers are applied as constraints on the textual user interface element to align the large language model with a specific use case.

10. The method of claim 9, wherein the one or more identifiers include a system identifier that identifies a language style of the textual user interface element.

11. The method of claim 8, wherein processing the initial textual user interface element based on the first criteria to generate the processed textual user interface element comprises post-processing the initial textual user interface element using at least one of a rule-based process or an LLM-based process to determine whether the initial textual user interface element meets the first criteria.

12. The method of claim 8, further comprising: implementing a user interface generator that receives the textual user interface element generated based on the modified input and displays the textual user interface element on an interface that enables user input.

13. The method of claim 8, further comprising: receiving feedback data that generates input prompts based on approved textual user interface elements.

14. The method of claim 8, wherein the textual user interface element includes an approved message.

15. A non-transitory computer readable medium having instructions stored thereon, wherein the instructions, when executed by at least one processor, cause at least one device to perform operations comprising:
receiving a request to generate a textual user interface element for a selected interface element package, wherein the request comprises a plurality of targeted characteristics of the textual user interface element;
in response to receiving the request:
generating an input prompt based on the plurality of targeted characteristics;
generating an initial textual user interface element using a pretrained model based on the input prompt;
processing the initial textual user interface element based on first criteria to generate a processed textual user interface element;
modifying at least the first criteria or the input prompt based on feedback information of the processed textual user interface element to generate a modified input; and
generating the textual user interface element based on the modified input.

16. The non-transitory computer readable medium of claim 15, wherein the pretrained model comprises a large language model, wherein the plurality of targeted characteristics of the textual user interface element are derived from one or more identifiers included in the request to generate the textual user interface element, and wherein the one or more identifiers are applied as constraints on the textual user interface element to align the large language model with a specific use case.

17. The non-transitory computer readable medium of claim 16, wherein the one or more identifiers include a system identifier that identifies a language style of the textual user interface element.

18. The non-transitory computer readable medium of claim 15, wherein processing the initial textual user interface element based on the first criteria to generate the processed textual user interface element comprises post-processing the initial textual user interface element using at least one of a rule-based process or an LLM-based process to determine whether the initial textual user interface element meets the first criteria.

19. The non-transitory computer readable medium of claim 15, wherein the instructions cause the processor to implement a user interface generator that receives the textual user interface element generated based on the modified input and displays the textual user interface element on an interface that enables user input.

20. The non-transitory computer readable medium of claim 15, wherein the instructions cause the processor to receive feedback data that generates input prompts based on approved textual user interface elements.
